(19) United States
(12) Patent Application Publication
(10) Pub. No.: US 2009/0139342 A1
(43) Pub. Date: Jun. 4, 2009

(54) DEVICE WITH DETECTION BY SUSPENDED PIEZORESISTIVE STRAIN GAUGE COMPRISING A STRAIN AMPLIFIER CELL

(76) Inventors: Philippe Robert, Grenoble (FR); Sebastien Hentz, Grenoble (FR)

Correspondence Address: PEARNE & GORDON LLP, 1801 EAST 9TH STREET, SUITE 1200, CLEVELAND, OH, 44114-3108, US

(21) Appl. No.: 12/267,971

(22) Filed: Nov. 10, 2008

(30) Foreign Application Priority Data
Nov. 30, 2007 (FR) 0759468

(51) Int. Cl. G01N 3/08

(52) U.S. Cl. 73/818

(57) ABSTRACT

A device, with piezoresistive detection comprising at least:
a proof body on which an effort to be measured is exerted,
means of detecting a strain exerted by the proof body under the action of the effort, comprising at least one suspended piezoresistive strain gauge,
a strain amplifier cell comprising at least two rigid arms mechanically linked to each other by at least one link element at the level of a first of their ends, a second end of a first of the two rigid arms being mechanically linked to the proof body, a second end of a second of the two rigid arms being fixed to the substrate, the link element being mechanically linked to a first end of the suspended piezoresistive strain gauge.

### TECHNICAL FIELD AND PRIOR ART

This document concerns the field of microcomponents or nanocomponents, particularly in silicon, for example inertial sensors, especially accelerometers, gyrometers or force sensors, resonant chemical sensors, and resonators.

It finds application in varied fields, such as the automotive sector, mobile telephones or avionics, to form for example a time base or carry out a mechanical filtering.

In a known manner, resonant sensors may be formed:
either using volume technology, in which case the sensitive element of the sensor is formed over the whole thickness of a substrate in silicon or in quartz by humid etching steps,
or using surface technology, in which case the silicon substrate is machined uniquely over a fraction of its thickness, for example between several micrometres and several tens of micrometres. The document “Resonant accelerometer with self-test”, by M. Aikele et al., Sensors and Actuators A 92 (2001), Elsevier, pages 161 to 167, describes an example of such a resonant sensor.

In a resonant inertial sensor formed using surface technology, the resonator vibrates in the plane of the substrate and excitation/detection electrodes are obtained by DRIE (deep reactive ion etching) plasma etching in the substrate. Machining by DRIE plasma etching, then freeing the elements of the sensor by etching a sacrificial layer make it possible to optimise the design of the sensor, and especially to bring the resonator closer to embedment or fixing hinges, linking it to the rest of the substrate.

In a resonant sensor based on silicon, the detection of vibration is achieved by electrostatic means, piezoresistive means with implanted resistances, or even by piezoelectric means. Yet, in the case of a miniaturisation of this type of sensor, for example in the context of forming NEMS (Nano Electro Mechanical Systems), these types of detection become problematic due to the very low measurement capacity in the case of an electrostatic detection, the difficulty of forming piezoresistive gauges by implantation, or the problem, in the case of piezoelectric gauges, linked to the deposition of a piezoelectric material on the resonator, leading to a lowering of the quality factor.

In the case of resonant sensors with MEMS (Micro Electro Mechanical Systems) type piezoresistive detection, gauges situated on the surface of a proof body only detect a normal strain caused by an out-of-plane flexing movement, in other words normal to a plane of the substrate from which is formed the sensor. This implies:
an important restriction in the possible designs of sensors, notably in the case of integrated bi-axial sensors such as inertial sensors,
a poor adaptation to sensors formed using surface technology,
a poor adaptation to “ultra-miniaturised” sensors, such as NEMS, in so much as it is difficult to define, with a sufficient precision and without adding mechanical strains due to the metallisations on the proof body, the doping and connector zones for the formation of gauge bridges on beams of several tens of nanometres width.

The document “High-mode resonant piezoresistive cantilever sensors for tens-femtogram resoluble mass sensing in air”, by Dazhong Jin et al., 2006, J. Micromech. Microeng 16, pages 1017 to 1023, describes another type of sensor in which piezoresistive gauges are formed by deposition of a conductive layer on the resonator. But such a deposition can lead to several major drawbacks:
the addition of strains at the level of the beam,
a reduction in the quality factor of the resonator,
the appearance of critical steps in addition to the actual steps of formation of the resonator (deposition of a very thin film of conductive material with a very strict control of the thickness, alignment, photolithography and etching of gauges on the beam),
a detection that takes place out-of-plane, which may be a drawback in terms of design, especially if it is wished to have an electrostatic excitation insulated from the substrate, for example in the case of a resonator in monocrystalline silicon,
a low piezoresistive coefficient (compared to a silicon gauge) inducing a lower sensitivity.

The document “Single-mask SOI fabrication process for linear and angular piezoresistive accelerometers with on-chip reference resistors”, by J. Eklund et al., Sensors, 2005, IEEE, 30 October to the 3 Nov. 2005, pages 656 to 659, describes another type of sensor in which the gauges are defined by etching of the silicon. The silicon is no longer surface doped and the detection (tension, compression) takes place in the plane. Such a configuration, known as suspended gauge, is well suited to a surface technology and the formation of sensors of very small dimensions (NEMS) compared to implanted or deposited type gauges. On the other hand, in the case of a sensor of small dimensions, having a small seismic mass, the sensitivity of the sensor is low.

### DESCRIPTION OF THE INVENTION

Thus there is a need to propose a device, or microcomponent or nanocomponent, of sensor and/or resonator type, advantageously formed using surface technology, having a high sensitivity and precision (high signal/noise ratio, low temperature drift), adaptable to NEMS, in other words to sensors of very small dimensions (nanometric scale).

To overcome these problems, one embodiment proposes forming a device, or microcomponent or nanocomponent, with piezoresistive detection formed advantageously using surface technology, comprising at least:
a proof body on which an effort to be measured is exerted,
means of detecting a strain exerted by the proof body under the action of the effort, comprising at least one suspended piezoresistive strain gauge,
a strain amplifier cell comprising at least two rigid arms mechanically linked to each other by at least one link element at the level of a first of their ends, a second end of a first of the two rigid arms being mechanically linked to the proof body, a second end of a second of the two rigid arms being fixed to a substrate, said link element, or the first ends of the two rigid arms, being mechanically linked to a first end of the suspended piezoresistive strain gauge.

Proof body is taken to mean any mechanical element capable of being deformed under the effect of an external strain (acceleration, pressure, temperature, etc.). For example, in the case of inertial sensors, the proof body may correspond to one or several seismic masses. In the case of a resonator or a resonant sensor, the proof body may correspond to one or several resonant structures, also known as resonators.

When the device is of resonator or resonant sensor type, only the frequency of the piezoresistive signal is detected at the terminals of the suspended piezoresistive strain gauge, and not its amplitude. Both the high sensitivity of the frequential variation detection and the simplicity of implementing the piezoresistive detection are thereby profited from.

Furthermore, with this type of device, it is possible to circumvent a metallisation of the resonator or an implantation of the gauge, which are very restrictive techniques from a technological point of view, which can also degrade the performance of the device.

The device may be used to form an oscillator, a resonator or any sensor, resonating or not, (accelerometer, gyrometer, pressure, mass or biochemical sensor, etc.).

When the device is not of resonator or resonant sensor type, the amplifier cell may also transmit the amplitude of the piezoresistive signal detected.

The “half-jack” or chevron structure of the amplifier cell formed by the rigid arms makes it possible to form the connections necessary for the piezoresistive measurement, preferentially in gauge bridge or Wheatstone bridge, since one of the ends of the gauge is thereby fixed to the substrate.

The structure is adapted to a “surface technology” type fabrication, applicable to MEMS or NEMS type components. The proof body, the detection means, in other words at least the suspended piezoresistive strain gauge, and the elements of the strain amplifier cell may be formed in a same plane, in other words all have a common plane. Furthermore, the strain gauge and the proof body may be formed in a same piezoresistive material.

The amplifier cell may be advantageously used to detect the vibration frequency of a resonant beam, but also any vibrating structure forming a proof body, thereby offering great freedom concerning the design of the device.

The suspended piezoresistive strain gauge may comprise a second end fixed to the substrate.

The suspended piezoresistive strain gauge may comprise at least one suspended beam based on a piezoresistive material.

Advantageously, the device may comprise at least two suspended piezoresistive strain gauges, thereby enabling a differential measurement to be carried out. Generally speaking, the amplifier cell may be used in a differential manner on a structure, resonant or not, or even on two sensors assembled in differential manner.

Advantageously, the second end of the first rigid arm may be linked to the proof body in the vicinity of an embedment from the proof body to the substrate.

The link element mechanically linking the two first ends of the two rigid arms may comprise at least one pivot link.

The link element mechanically linking the first ends of the two rigid arms may comprise a fixed link with the first end of the suspended piezoresistive strain gauge.

In this case, each of the first ends of the two rigid arms may be mechanically linked to the link element by at least one pivot link.

The two rigid arms may be symmetrical in relation to a principal axis of the suspended piezoresistive strain gauge.

The proof body may comprise at least one mobile seismic mass in the plane of the substrate, to which may be connected the second end of the first rigid arm.

The seismic mass may be fixed to the substrate through the intermediary of a hinge.

The seismic mass may be fixed to the substrate through the intermediary of a guiding arm formed in the seismic mass and embedded in the substrate.

In an alternative embodiment, the proof body may comprise at least one resonant element flexing in the plane of the substrate. The resonant element may be of beam or diapason type.

The device may further comprise excitation means of the resonant element, of capacitive, and/or piezoelectric, and/or mechanical and/or thermoelastic type.

Two ends of the resonant element may be fixed to the substrate.

The proof body may further comprise at least one mobile seismic mass in the plane of the substrate, linked to the resonant element.

The seismic mass may be fixed to the substrate through the intermediary of a hinge.

The resonant element may be linked to the seismic mass in the vicinity of an embedment of the seismic mass to the substrate.

The proof body may comprise at least two mobile seismic masses in the plane of the substrate, two link arms linked to each of the two seismic masses through the intermediary of flexing arms intended to transmit the movements of the seismic masses to the link arms, wherein the second end of the first rigid arm of the strain amplifier cell may be linked to one of the link arms in the vicinity of an embedment of said link arms to the substrate.

In this case, the link arms and the flexing arms may form for example a substantially rectangular frame.

The device may further comprise excitation means of the seismic masses of electrostatic and/or thermal and/or piezoelectric type.

The device may further comprise at least one second strain amplifier cell that may comprise at least two rigid arms mechanically linked to each other by at least one link element at the level of a first of their ends, wherein a second end of a first of the two rigid arms may be mechanically linked to the proof body, a second end of a second of the two rigid arms may be fixed to the substrate, said link element, or the first ends of the two rigid arms, may be mechanically linked to a first end of a second suspended piezoresistive strain gauge intended to work in a differential manner in compression or tension in relation to the first suspended piezoresistive strain gauge working respectively in tension or in compression.

The device may further comprise at least two resistive elements and a polarisation source that can form, with the other elements of the device, a Wheatstone bridge.

The device may further comprise means of measuring the variation in the resistance of the suspended piezoresistive strain gauge.

The suspended piezoresistive strain gauge(s) may be arranged perpendicularly to the axis of the induced effort (for example the acceleration or the rotation) to be measured.

The device may be a sensor such as an accelerometer or a gyrometer, resonant or not, or a resonator.

Another embodiment concerns a method of forming a device, or microcomponent or nanocomponent, as described previously, comprising at least the steps of:

a) depositing a layer based on at least one conductive material (for example a tri-layer based on titanium, nickel and gold) on a substrate comprising a first layer based on at least one semi-conductor on which is arranged a sacrificial layer and a second layer based on semi-conductor,

b) photolithography and etching of electrical contacts of the device in the layer based on conductive material,

c) photolithography and etching of the mechanical structure of the device in the second semi-conductor based layer, with stoppage on the sacrificial layer,

d) freeing of the elements of the device by etching of the sacrificial layer at the level of these elements.

The substrate used may for example be an SOI (silicon on insulator) substrate.

The method may further comprise, between steps b) and c), the steps of:
depositing, for example by photolithography, a protective layer on the mechanical structure of the device, except on the suspended piezoresistive strain gauge,
thinning, for example by etching with stoppage at the end of a set period, of the suspended piezoresistive strain gauge,
removing the protective layer.

### BRIEF DESCRIPTION OF DRAWINGS

The present invention will be better understood on reading the description of embodiments, given solely by way of indication and in no way limiting and by referring to the appended figures, among which:

FIG. 1 represents a resonator with electrostatic excitation and suspended piezoresistive detection comprising a strain amplifier cell,

FIG. 2 represents a resonant accelerometer with detection by suspended piezoresistive strain gauge comprising a strain amplifier cell,

FIG. 3 represents a resonant gyrometer with detection by suspended piezoresistive strain gauge comprising a strain amplifier cell,

FIG. 4 represents a non resonant accelerometer with detection by suspended piezoresistive strain gauge comprising a strain amplifier cell,

FIG. 5 represents a strain amplifier cell comprising an electrical track formed on one of the rigid arms of the cell,

FIG. 6 represents a non resonant accelerometer with detection by suspended piezoresistive strain gauge comprising a strain amplifier cell,

FIG. 7 represents a resonator with detection by suspended piezoresistive strain gauges assembled in differential mode and with Wheatstone bridge, comprising two strain amplifier cells,

FIG. 8 represents a non resonant accelerometer with detection by suspended piezoresistive strain gauges assembled in differential mode and with Wheatstone bridge, and comprising two strain amplifier cells,

FIG. 9A represents an accelerometer with detection by suspended piezoresistive strain gauges assembled in differential mode and with Wheatstone bridge, comprising two strain amplifier cells,

FIG. 9B represents an equivalent electrical circuit of the Wheatstone bridge formed by the accelerometer represented in FIG. 9A,

FIGS. 10A to 10C and 10A′ to 10C′ represent the steps of a first example of method of formation of one embodiment, respectively in sectional and top views,

FIGS. 11A to 11F and 11A′ to 11F′ represent the steps of a second example of method of formation of one embodiment, respectively in sectional and top views.

Identical, similar or equivalent parts of the different figures described hereafter bear the same number references so as to make it easier to go from one figure to the next.

In order to make the figures more legible, the different parts represented in the figures are not necessarily to a uniform scale.

The different possibilities (alternatives and embodiments) should be understood as not being mutually exclusive and may be combined together.

### DETAILED DESCRIPTION OF SPECIFIC EMBODIMENTS

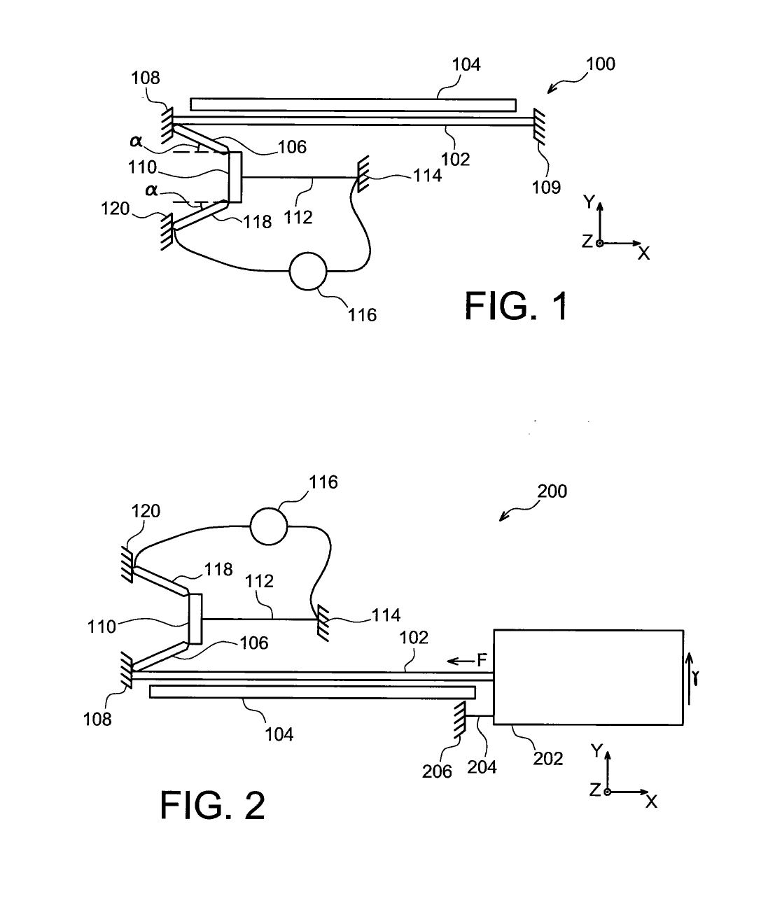

Reference will firstly be made to FIG. 1, which represents a microcomponent 100 according to a first embodiment.

In this first embodiment, the microcomponent 100 is a resonator, of MEMS or NEMS type. The resonator 100 comprises a resonant element 102, or resonant structure, for example of beam type, flexing in a plane (x,y) corresponding to the plane of a substrate (not represented) from which is formed the resonator 100. In an alternative embodiment, the resonant element 102 may be of diapason type, in other words formed by at least two beams linked to each other at the level of one of their ends. The resonant element 102 is intended to be excited by excitation means 104, for example an excitation electrode. These excitation means 104 may be of capacitive, and/or piezoelectric, and/or magnetic and/or thermoelastic type.

The resonant element 102 is joined, through the intermediary of a pivot link, to one end, known as second end, of a first rigid arm 106, near to a first embedment 108 of a first end of the resonant element 102 to the substrate on which is formed the resonator 100, thereby limiting the contribution of the first rigid arm 106 to the natural frequency of the resonant element 102. The distance between the first embedment 108 of the resonant element 102 and the pivot link between the resonant element 102 and the first rigid arm 106 is for example equal to around a tenth of the length of the resonant element 102. A second end of the resonant element 102 is linked to a second embedment 109 to the substrate. A first end of the first rigid arm 106 is linked by a pivot link to a link element 110, comprising a rigid or fixed link with a suspended piezoresistive strain gauge 112 thereby assuring the embedded-embedded limit conditions of the gauge 112, at the same time as the optimal transmission of the strain, coming from the resonant element 102 then amplified by the first rigid arm 106, to the gauge 112. The gauge 112 is for example formed by etching of a beam suspended in a piezoresistive material, preferentially of doped silicon, in order to reduce the value of the resistance of the gauge 112. The other end of the piezoresistive gauge 112 is linked to the substrate through the intermediary of a third embedment 114 to the substrate also linked to means of measuring 116 the variation in the resistance ΔR of the gauge 112.

The resonator 100 further comprises a second rigid arm 118, a first end of which is linked, through the intermediary of one pivot link, to the link element 110, and a second end is linked, through the intermediary of another pivot link, to a fourth embedment 120 to the substrate. Each of the four embedments to the substrate 108, 109, 114 and 120 forms a fixed link with the substrate on which is formed the resonator 100.

The two rigid arms 106 and 118 are placed in such a way as to constitute half a “jack” or chevron. The two rigid arms 106 and 118, and the link element 110 form a strain amplifier cell of the resonator 100. All of the elements of the resonator 100, save for the embedments 108, 109, 114 and 120, are for example freed from the substrate by etching of a sacrificial layer arranged under the layer in which are formed the elements of the resonator 100.

When the resonant element 102 is subjected to a flexing force parallel and in the direction opposite to the y vector (represented in FIG. 1), the resonant element 102 flexes in the direction of this force and then transmits a strain in the opposite direction to the y vector at the level of the first end of the first rigid arm 106. This strain applied to the first rigid arm 106 results in a displacement strain in the direction opposite to the y vector and a rotation strain of the first rigid arm 106 in an anticlockwise direction around the pivot linking its ends to the link element 110 and to the resonant element 102, thereby reducing the value of the angle a, angle formed between a parallel to the x vector and the axis of the rigid arm 106. The link element 110 thus undergoes a strain in the direction of the x vector resulting in a compression effort in the axis of the gauge 112.

Inversely, when the resonant element 102 is subjected to a flexing force parallel and in the direction of the y vector, the resonant element 102 flexes in the direction of this force, and transmits a strain in the direction of the y vector at the level of the first end of the rigid arm 106. This strain applied to the rigid arm 106 results in a displacement strain parallel and in the direction opposite to the x vector, and a rotation strain of the rigid arm 106 in a clockwise direction around pivot links between its ends linked to the link element 110 and to the resonant element 102, increasing the value of the angle α. The link element 110 thus undergoes a strain in the direction opposite to the x vector resulting in an extension effort in the axis of the gauge 112.

The second rigid arm 118 accompanies, in a complementary movement to that of the first rigid arm 106, the axial displacements of the link element 110.

Thus, the alternating flexing movement parallel to the y vector of the resonant element 102 leads to an alternating variation in the resistance of the gauge 112 due to the displacement strains parallel to the x vector undergone by the gauge 112. The rigid arms 106 and 118 thus make it possible to amplify the flexing strains of the resonant element 102 then to apply them to the link element 110 and to the gauge 112. The two rigid arms 106, 118 and the link element 110 thereby form a strain amplifier cell.

Since the ratio of amplification of the displacements of the resonant element 102, along the axis of the y vector, and the link element 110, along the axis of the x vector, is around 1/tan(α), in order to profit to the maximum from the amplification effect, a value of α less than around 45° is preferably chosen.

Preferably, the rigid arm(s) 106, 108 comprise a relatively wide body, with thin ends capable of flexing in relation to the body, and thereby assuring at least in part the pivot links. For example, in the case of a MEMS type device, for a rigid arm body, the width of which is equal to around 10 μm, the ends of the rigid arms may have a width equal to around 2 μm.

Finally, since the variations in the value of the resistance of the gauge 112 are directly proportional to the longitudinal strains that it undergoes, it is advisable, to maximise the detection sensitivity of the gauge 112, to reduce as much as possible the section of the gauge 112, within the limit of its buckling strain in compression. Typically, the value of this section may be less than the value of the section of the rigid arms 106, 118, at the level of their central parts (body). The section of the gauge 112 may even be thinned in the thickness (dimension along the normal to the plane (x,y)), and be of a thickness less than that of the other elements of the resonator 100.

Reference will now be made to FIG. 2, which represents a microcomponent 200, here a resonant sensor, according to a second embodiment.

The resonant sensor 200, here of accelerometer type, comprises a resonant element 102 in which one of its ends is fixed to the substrate on which is formed the sensor 200, through the intermediary of a first embedment 108, and attached at the level of its other end to a seismic mass 202, in the vicinity of a hinge 204 linking the seismic mass 202 to a second embedment 206 to the substrate. The sensor 200 also comprises excitation means 104, for example electrostatic, here an electrode, of the resonant element 102, an amplifier cell formed by two rigid arms 106, 118 and a link element 110 linked to a first end of a suspended piezoresistive strain gauge 112 which is also linked, at the level of a second end, to a third embedment 114. The amplifier cell and the gauge 112 are arranged in the vicinity of the first embedment 108 of the resonant element 102. Finally, the sensor 200 comprises means of measuring 116 variations in the resistance ΔR of the gauge 112.

In the case of an acceleration γ (represented in FIG. 2), in the direction of the y vector, the seismic mass 202 is subject to a force along the y axis which tends to make the mass turn in rotation at the level of the hinge 204, resulting in a strain F (also represented in FIG. 2) on the resonant element 102 in the opposite direction to the x vector. This strain F induces a variation in the resonance frequency of the resonant element 102. The natural frequency of the resonant element 102 is then modified by the strain exerting on the resonant element 102. The detection of the vibration is achieved by the gauge 112, the strain on the gauge 112 being amplified by the amplifier cell.

In the examples described above, the amplifier cell is used advantageously to amplify the strain, stemming from the vibration of the resonant element, on the gauge 112. In an alternative embodiment, this amplifier cell may be used to measure the resonance frequency of any other resonant element, by judiciously choosing the emplacements of the resonant element at the level of which the amplifier cell is linked, advantageously near to embedments of the resonant element.

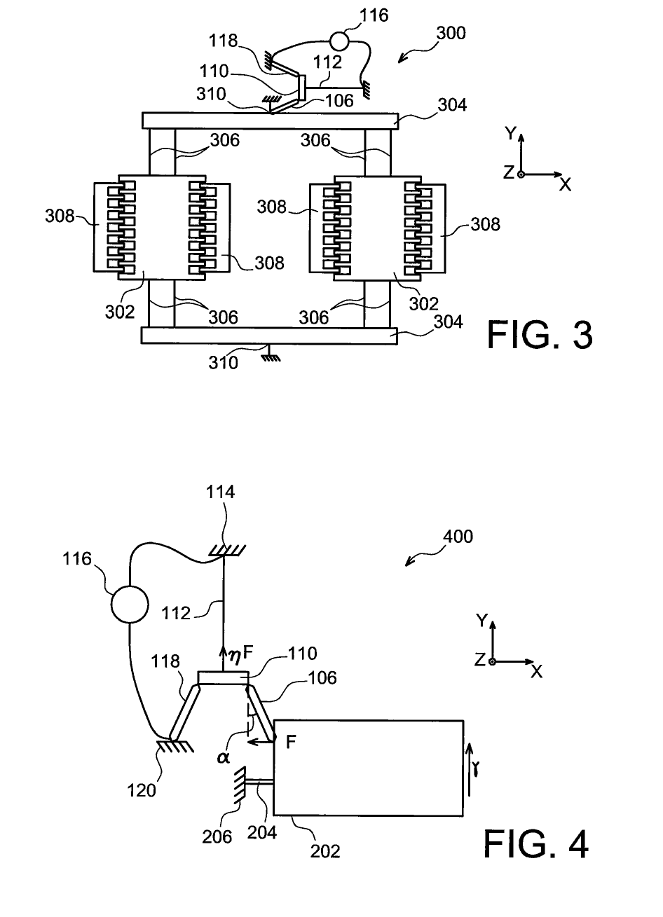

FIG. 3 represents a microcomponent 300, here a resonant gyrometer, according to a third embodiment. The gyrometer 300 comprises a substrate, not represented, and two mobile seismic masses 302 in the plane (x,y) of the substrate and capable of entering into vibration. Two link arms 304, here parallel to each other, are linked to the seismic masses 302 through the intermediary of flexing arms 306, the flexibility of which is sufficient to enable relative movements of the two seismic masses 302 in relation to the link arms 304, while being sufficiently rigid to transmit the movements of these two seismic masses 302 to the link arms 304. The link arms 304 and the flexing arms 306 here form a rectangular frame.

The gyrometer 300 also comprises excitation electrodes 308, for example in comb form, the fingers of which overlap with those of the seismic masses 302, capable of placing the seismic masses 302 in vibration in the plane (x,y), and especially in a direction parallel to the x vector. Other means may be envisaged, for example electromagnetic means.

The seismic masses 302 are excited, preferably to their resonance frequency or close to this resonance frequency, by means of electrostatic forces applied by the intermediary of the electrodes 308. The seismic masses 302, the link arms 304 and flexing arms 306 form an excitation resonator. Functioning at the resonance makes it possible to obtain a high displacement amplitude of the seismic masses 302 (on account of the quality factor of the resonator), accordingly increasing the sensitivity of the gyrometer 300. Advantageously, the vibration of each of the seismic masses 302 may be in phase opposition with the vibration of the other seismic mass 302, in other words that their movements are in opposite directions at each instant.

When the gyrometer 300 undergoes an angular displacement around a z axis perpendicular to the substrate on which is formed the gyrometer 300, a Coriolis force is generated on each of the seismic masses 302, parallel to the y vector, stemming from the composition of the vibration forced by the electrodes 308 with an angular velocity Ω. The Coriolis forces are transmitted to the link arms 304 through the intermediary of flexing arms 306. Each of the link arms 304 is linked to the substrate through the intermediary of a hinge 310. One of the link arms 304 is linked to the amplifier cell formed by the rigid arms 106, 118 and the link element 110 linked to the gauge 112, near to a hinge 310. The variation in the resistance measured by the measuring means 116 is proportional to the angular velocity Ω relative to the rotation of the seismic masses 302 at the level of the hinges 310.

The amplifier cell may also be used to achieve an amplification of non alternating movements (non resonant sensor), static or slowly variable, with a high sensitivity, since by being correctly dimensioned, it increases in a noticeable manner the amplitude of the piezoresistive signal obtained. Preferably, in this type of sensor, a stability control of the temperature of the suspended piezoresistive strain gauge is carried out so that temperature variations do not influence the resistance measurements carried out.

Reference is now made to FIG. 4 which represents a non resonant sensor, here an accelerometer 400. This accelerometer 400 comprises a hinge 204 linking a seismic mass 202 to a second embedment 206 to the substrate. The accelerometer 400 also comprises an amplifier cell formed by the rigid arms 106, 118 and the link element 110 linked to the suspended piezoresistive strain gauge 112. The rigid arm 118 of the amplifier cell is fixed to the substrate through the intermediary of an embedment 120, and the rigid arm 106 is attached to the seismic mass 202 in the vicinity of the hinge 204. Under the effect of an acceleration γ, the seismic mass 202 applies a strain F to the arm 106 of the amplifier cell in the opposite direction to the x axis, resulting in a strain ηF, where η≈1/tan(α), on the gauge 112 along the y axis. The variation in the resistance of the suspended piezoresistive strain gauge 112, amplified by the amplifier cell, is then directly proportional to the acceleration. This variation is then measured by the measuring means 116.

Whatever the type of sensor and/or resonator, it is possible to carry out the measurements of variation in the resistances of the suspended piezoelectric strain gauge by linking the measuring means directly to one of the ends of the suspended piezoresistive strain gauge that is linked to one embedment and to one of the rigid arms of the amplifier cell which is based on at least one semi-conductor or conductor material. The fact that the resistance measurement is carried out through one of the rigid arms and the link element induces a supplementary series resistance slightly influencing the measurement.

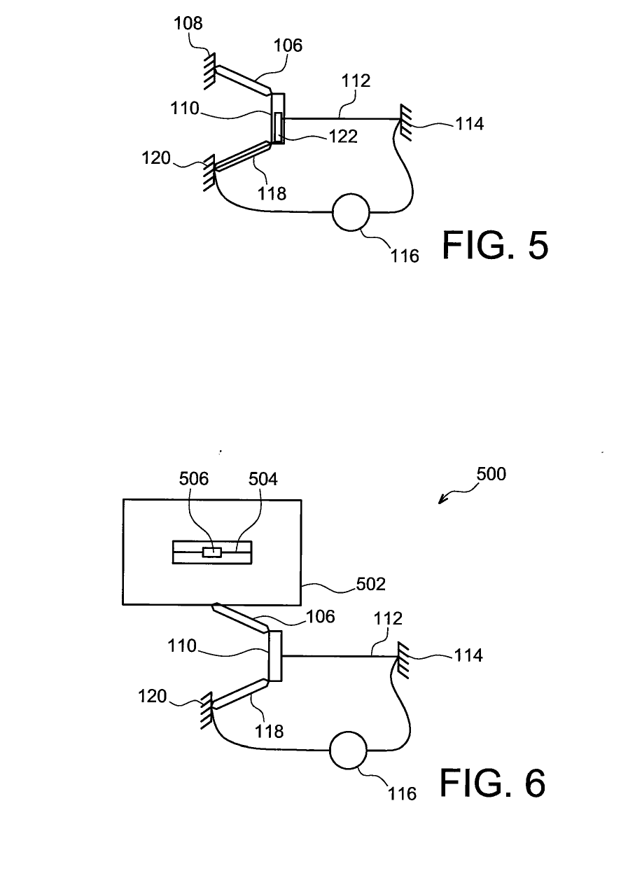

In an alternative embodiment, as represented in FIG. 5, it is possible that an electrical track 122 is arranged on one of the rigid arms 118 of the amplifier cell and at least in part on the link element 110, the measurement of the variation in the resistances of the gauge 112 being carried out through the intermediary of this electrical track 122. This alternative is conceivable if the rigid arm 118 and the link element 110 are sufficiently wide to be able to comprise such an electrical track 122, and that this electrical track 122 does not induce significant strains on the structure of the amplifier cell.

FIG. 6 represents a microcomponent 500 of non resonant accelerometer type, according to another embodiment. This accelerometer comprises an amplifier cell comprising the rigid arms 106, 118 and the link element 110. The accelerometer 500 also comprises a seismic mass 502 in which is formed a guiding arm 504 linked to an embedment 506 to the substrate on which is formed the accelerometer 500. The operation of this accelerometer is substantially similar to that described in relation to FIG. 4.

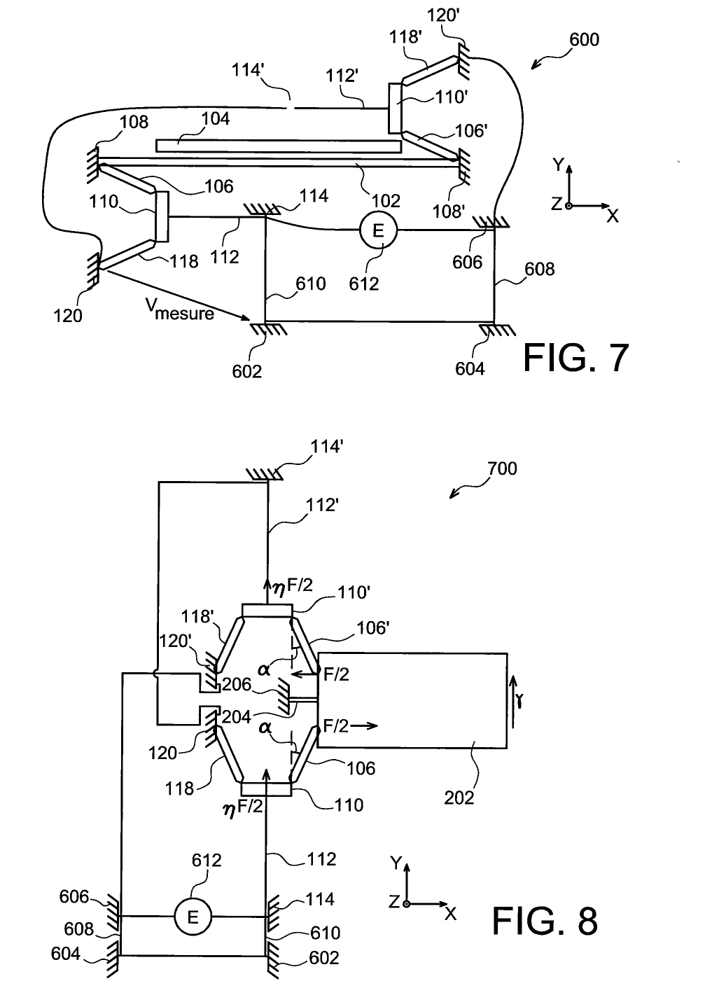

FIG. 7 represents a resonator type microcomponent 600 with piezoresistive detection assembled in differential mode and Wheatstone bridge.

The resonator 600 comprises a beam type resonant element 102, excitation means 104, here an electrode, of the resonant element 102. As in the resonant device 100, the resonator 600 comprises a first amplifier cell formed by two rigid arms 106, 118 linked to a link element 110 itself linked to a suspended piezoresistive strain gauge 112. This amplifier cell is linked to a first end of the resonant element 102. The other end of the resonant element 102 is linked to a second amplifier cell formed by a third rigid arm 106′ arranged between said other end of the resonant element 102, near to an embedment 108′ to the substrate of this end, and a link element 110′ linked to a second suspended piezoresistive strain gauge 112′. A fourth rigid arm 118′ is arranged between an embedment 120′ to the substrate and the link element 110′.

The resonator 600 also comprises other elements used to form a Wheatstone bridge, such as embedments to the substrate 602, 604 and 606, resistive elements 608, 610, and a polarisation source 612. A tension is measured between the embedment 120 of the second rigid arm 118 and the embedment 602 of one of the resistive elements 610. A measurement of resistance R+ΔR (where ΔR is the variation in the resistance of the first suspended piezoresistive strain gauge 112) is then obtained at the level of the first gauge 112, and a measurement of resistance R−ΔR (where −ΔR is the variation in the resistance of the second suspended piezoresistive strain gauge 112′) at the level of the second gauge 112′.

A functioning in differential mode of a resonant structure is thereby obtained, the two amplifier cells being complementary to achieve the amplification of movements of the resonant element 102.

FIG. 8 represents a non resonant accelerometer type microcomponent 700 with detection by suspended piezoresistive strain gauges assembled in differential mode and with Wheatstone bridge.

The accelerometer 700 comprises the same elements as the resonator 600, except for the resonant element 102 and the excitation means 104 which are replaced by a seismic mass 202 that is fixed to the substrate by an embedment 206 via a hinge 204. The second ends of the rigid arms 106, 106′ are linked directly to the seismic mass 202.

When the seismic mass 202 is subjected to an acceleration γ in the direction of the y axis, the seismic mass 202 exerts a strain of intensity F/2 in tension on the second end of the rigid arm 106 which is linked to the seismic mass 202, in the direction of the x axis. The seismic mass also exerts another strain of intensity F/2 in compression on the second end of the rigid arm 106′ which is linked to the seismic mass 202, in the opposite direction to the x axis. These strains are passed along at the level of link elements 110 and 110′. Thus, the gauges 112 and 112′ each undergo a strain in the direction of the y axis, the intensity of which is equal to ηF/2, where η≈1/tan(α), α being the angle formed between the axis of the rigid arms 106, 106′ and a straight line parallel to the y axis.

A tension is measured between the embedment 120 of the second rigid arm 118 and the embedment 602 of one of the resistive elements 610. A measurement of resistance R+ΔR (where ΔR is the variation in the resistance of the first suspended piezoresistive strain gauge 112) is then obtained at the level of the first gauge 112, and a measurement of resistance R−ΔR (where −ΔR is the variation in the resistance of the second suspended piezoresistive strain gauge 112′) at the level of the second gauge 112′.

A functioning in differential mode of a resonant structure is thereby obtained, the two amplifier cells being complementary to achieve the amplification of movements of the seismic mass 202. The acceleration γ may be finally calculated in a conventional manner from the parameters of the elements forming the Wheatstone bridge.

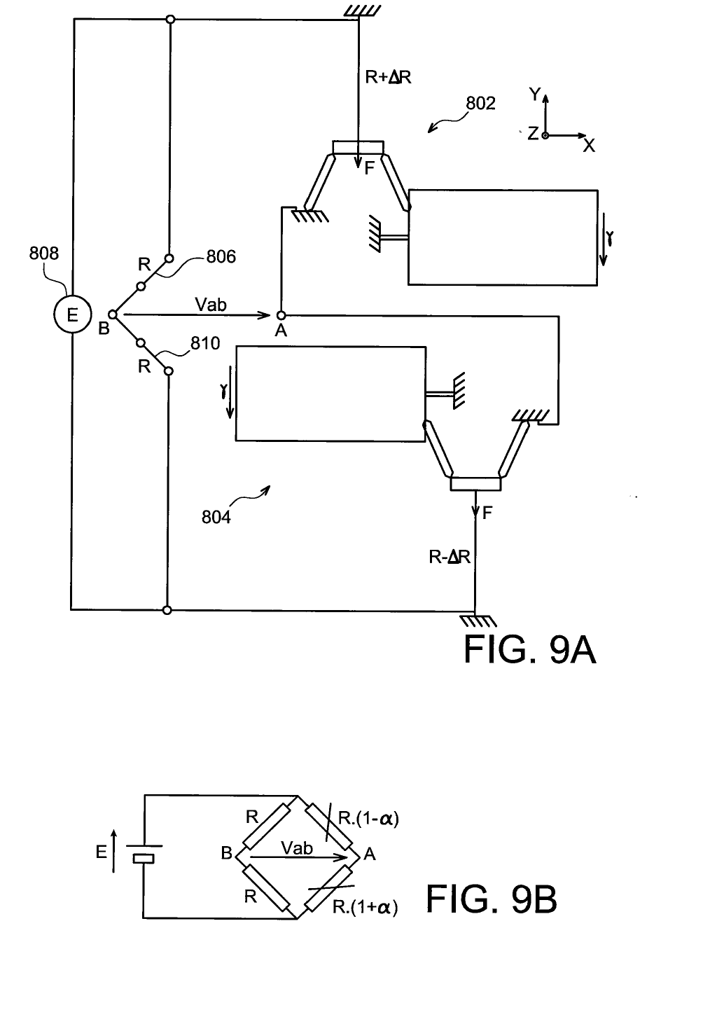

It is also possible to form a microcomponent comprising several sensors, resonant or not, assembled in differential manner. FIG. 9A represents an example of such a microcomponent 800 of non resonant accelerometer type, assembled in differential manner and in Wheatstone bridge.

The accelerometer 800 comprises a first and a second non resonant sensor 802, 804 of accelerometer type, for example similar to the accelerometer 400 represented in FIG. 4. Each of the sensors 802, 804 comprises a seismic mass, a strain amplifier cell and a suspended piezoresistive strain gauge. One of the rigid arms of the amplifier cell of the first sensor 802 comprises a first end mechanically linked to a link element, itself linked to a strain gauge, and a second end electrically connected to a second end of one of the rigid arms of the amplifier cell of the second sensor. The other rigid arm of the amplifier cell of the first sensor 802 comprises a first end linked to the link element and a second end linked to the seismic mass. One of the ends of the strain gauge is electrically connected to a first resistive R element 806 and to a terminal of a polarisation source 808. A second resistive R element 810 is electrically connected to the first resistive R element 806 and to an embedment of the suspended piezoresistive strain gauge of the second sensor 804.

One of the rigid arms of the amplifier cell of the second sensor 804 comprises a first end electrically connected to another link element, itself linked to one end of one strain gauge of the second sensor 804, and a second end electrically connected to the second end of one of the rigid arms of the strain amplifier cell of the first sensor 802. The other rigid arm of the amplifier cell of the second sensor 804 comprises a first end linked to the link element and a second end linked to the seismic mass. One of the ends of the strain gauge of the second sensor 804 is electrically connected to the second resistive element 810 and to the other terminal of the polarisation source 808.

Thus, the elements of the accelerometer 800 form a Wheatstone bridge assembly, a tension being measured between a first point B where the two resistive elements 806, 810 are linked, and a second point A electrically connected to the second ends of two rigid arms of the strain amplifier cell of the two sensors 802 and 804. This measurement makes it possible to obtain a measurement of resistance R+ΔR at the level of the suspended piezoresistive strain gauge of the first sensor 802, and a measurement of resistance R−ΔR at the level of the suspended piezoresistive strain gauge of the second sensor 804. The value of ΔR representative of an acceleration γ undergone by the seismic masses of the sensors 802 and 804 is then deduced. FIG. 9B schematically represents the Wheatstone bridge obtained by the assembly of FIG. 9A.

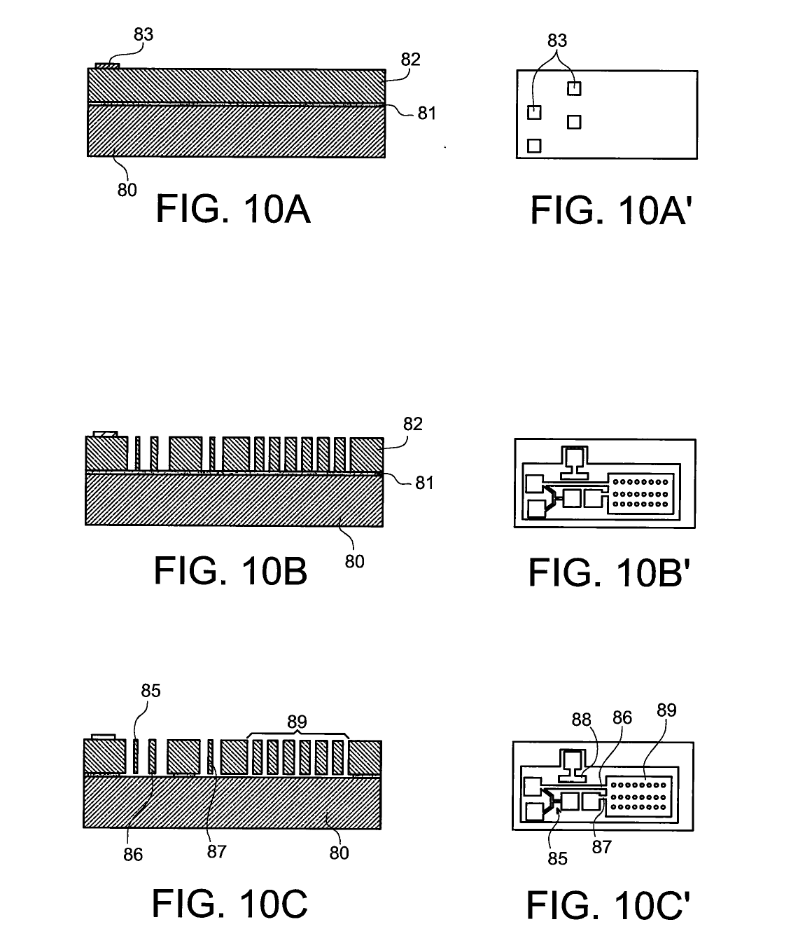

Reference will now be made to FIGS. 10A to 10C (sectional view) and 10A′ to 10C′ (top view), representing the steps of a first embodiment of one of the microcomponents described previously.

For example a tri-layer (3 layers) based on titanium, nickel and gold is deposited on a SOI substrate comprising a bulk substrate 80 based on silicon, a sacrificial layer based on SiO₂ 81 (for example of 0.4 μm thickness) and a silicon layer 82 (for example of 4 μm thickness). Contacts 83 are delimited by photolithography and etching (FIGS. 10A and 10A′).

The mechanical structure of the device is then delimited by photolithography and DRIE etching, in the silicon layer 82 with stoppage on the sacrificial layer 81 (FIGS. 10B and 10B′).

Finally, the components of the device are freed by exposure to hydrofluoric acid (humid or vapour) of the sacrificial layer 81 with stoppage at the end of a fixed time.

The device represented in FIGS. 10C and 10C′ comprises a suspended piezoresistive strain gauge and an amplifier cell 85, a resonant element 86, a hinge 87, an excitation electrode 88 of the resonant element, and a seismic mass 89.

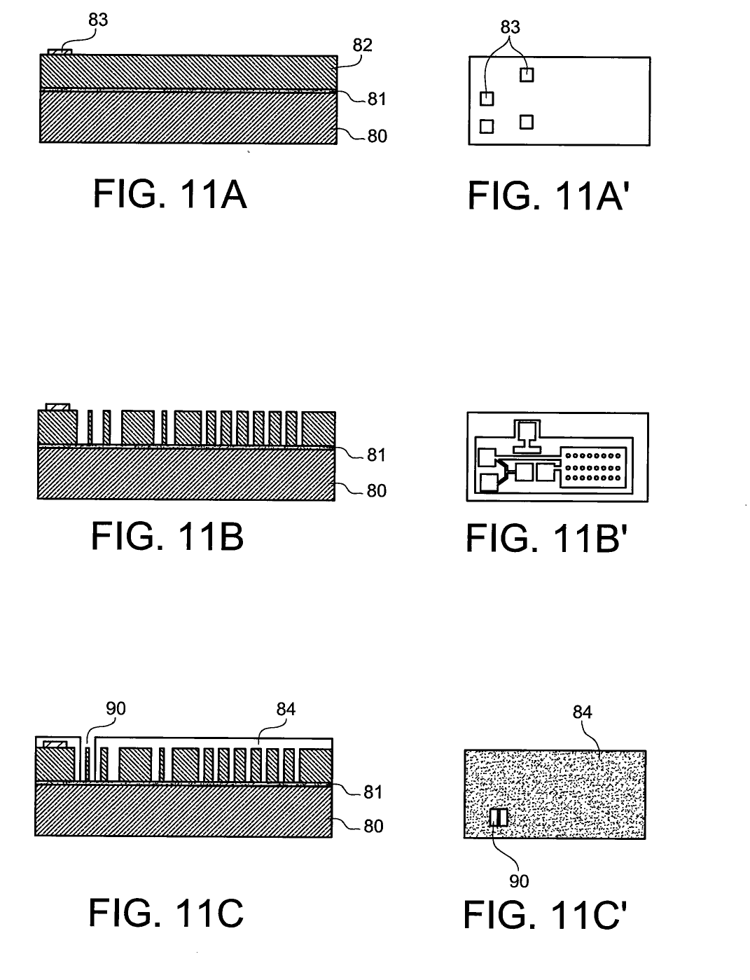

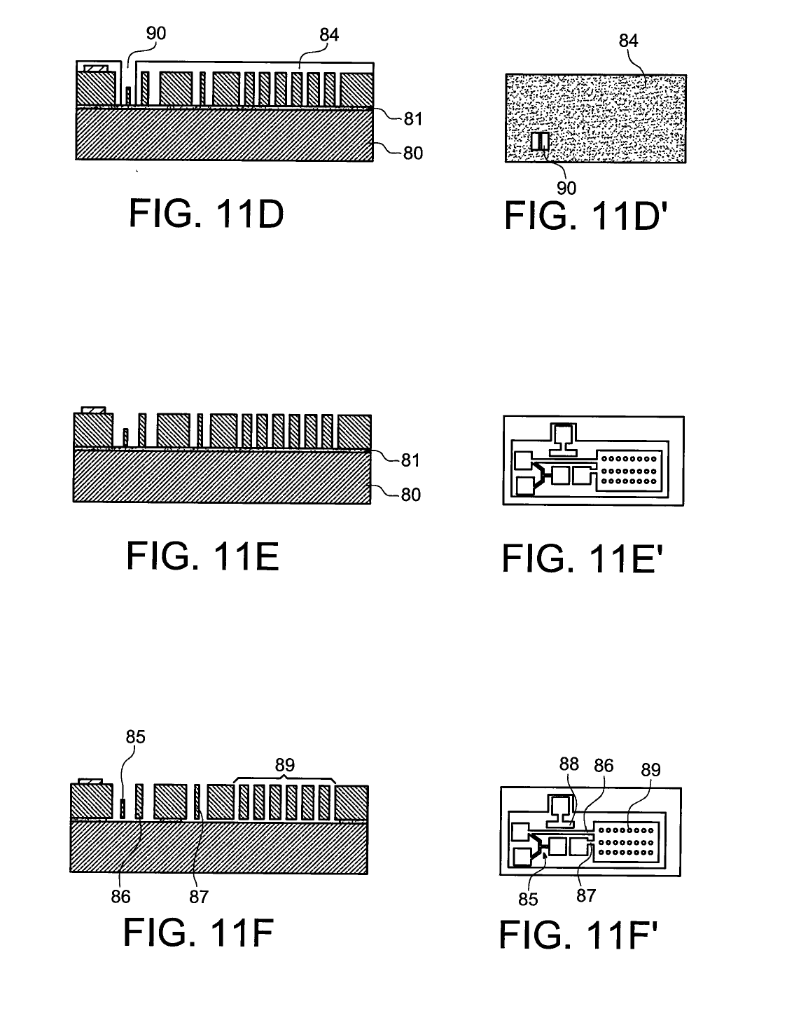

FIGS. 11A to 11F (sectional view) and 11A′ to 11F′ (top view) represent the steps of a second embodiment of one of the microcomponents described previously.

A tri-layer based on titanium, nickel and gold is deposited on a substrate for example of SOI type for example similar to that described previously. The contacts are delimited by photolithography and etching (FIGS. 11A and 11A′).

The mechanical structure of the device is delimited by photolithography and DRIE etching of the mechanical structure, in the silicon layer 82 with stoppage on the sacrificial layer 81 (FIGS. 11B and 11B′).

A protective layer 84 of the mechanical structure is deposited by photolithography, except in a zone 90 where the piezoresistive strain gauge of the device is situated (FIGS. 11C and 11C′).

The piezoresistive strain gauge 90 is then thinned by DRIE etching with stoppage at the end of a set period (FIGS. 11D and 11D′).

A stripping of the protective layer 84 (FIGS. 11E and 11E′) is carried out.

The components of the device are freed by exposure of the sacrificial layer 81 to hydrofluoric acid (humid or vapour) with stoppage at the end of a fixed period.

The two embodiment examples described above rely on the use of SOI substrates based on monocrystalline silicon. Nevertheless, this example is not limiting and the microcomponents or nanocomponents described above may be formed from substrate based on polycrystalline silicon, monocrystalline SiGe, polycrystalline SiGe, etc.

1. A device with piezoresistive detection, comprising at least:
a proof body on which an effort to be measured is exerted,
means of detecting a strain exerted by the proof body under the action of the effort, comprising at least one suspended piezoresistive strain gauge,
a strain amplifier cell comprising at least two rigid arms mechanically linked to each other by at least one link element at the level of a first of their ends, a second end of a first of the two rigid arms being mechanically linked to the proof body, a second end of a second of the two rigid arms being fixed to a substrate, the link element being mechanically linked to a first end of the suspended piezoresistive strain gauge.

2. The device according to claim 1, wherein the suspended piezoresistive strain gauge comprises a second end fixed to the substrate.

3. The device according to claim 1, wherein the suspended piezoresistive strain gauge comprises at least one suspended beam based on a piezoresistive material.

4. The device according to claim 1, wherein the second end of the first rigid arm is connected to the proof body in the vicinity of an embedment of the proof body to the substrate.

5. The device according to claim 1, wherein the link element mechanically links the two first ends of the two rigid arms comprising at least one pivot link.

6. The device according to claim 1, wherein the link element mechanically links the first ends of the two rigid arms comprising a fixed link with the first end of the suspended piezoresistive strain gauge.

7. The device according to claim 6, wherein each of the first ends of the two rigid arms is mechanically linked to the link element by at least one pivot link.

8. The device according to claim 1, wherein the two rigid arms are symmetrical in relation to a principal axis of the suspended piezoresistive strain gauge.

9. The device according to claim 1, wherein the proof body comprises at least one mobile seismic mass in the plane of the substrate, to which is linked the second end of the first rigid arm.

10. The device according to claim 9, wherein the seismic mass is fixed to the substrate through the intermediary of a hinge.

11. The device according to claim 9, wherein the seismic mass is fixed to the substrate through the intermediary of a guiding arm formed in the seismic mass and embedded in the substrate.

12. The device according to claim 1, wherein the proof body comprises at least one resonant element flexing in the plane of the substrate.

13. The device according to claim 12, wherein the resonant element is of beam or diapason type.

14. The device according to claim 12, further comprising excitation means of the resonant element of capacitive, and/or piezoelectric, and/or magnetic and/or thermoelastic type.

15. The device according to claim 12, wherein two ends of the resonant element are fixed to the substrate.

16. The device according to claim 12, wherein the proof body further comprises at least one mobile seismic mass in the plane of the substrate, linked to the resonant element.

17. The device according to claim 16, wherein the seismic mass is fixed to the substrate through the intermediary of a hinge.

18. The device according to claim 16, wherein the resonant element is linked to the seismic mass in the vicinity of an embedment of the seismic mass to the substrate.

19. The device according to claim 1, wherein the proof body comprises at least two mobile seismic masses in the plane of the substrate, two link arms linked to each of the two seismic masses through the intermediary of flexing arms intended to transmit the movements of the seismic masses to the link arms, the second end of the first rigid arm of the strain amplifier cell being linked to one of the link arms in the vicinity of an embedment of said link arms to the substrate.

20. The device according to claim 19, the link arms and the flexing arms forming a substantially rectangular frame.

21. The device according to claim 19, further comprising excitation means of seismic masses of electrostatic and/or thermal and/or piezoelectric type.

22. The device according to claim 1, further comprising at least one second strain amplifier cell comprising at least two rigid arms mechanically linked to each other by at least one link element at the level of a first of their ends, a second end of a first of the two rigid arms being mechanically linked to the proof body, a second end of a second of the two rigid arms being fixed to the substrate, the link element being mechanically linked to a first end of a second suspended piezoresistive strain gauge intended to work in differential manner in compression or tension in relation to the first suspended piezoresistive strain gauge working respectively in tension or in compression.

23. The device according to claim 22, further comprising at least two resistive elements and a polarisation source forming, with the other elements of the device, a Wheatstone bridge.

24. The device according to claim 1, further comprising means of measuring the variation in the resistance of the suspended piezoresistive strain gauge.

25. The device according to claim 1, the suspended piezoresistive strain gauge(s) being arranged perpendicularly to the axis of the induced effort to be measured.
